(19) United States
(12) Patent Application Publication
(10) Pub. No.: US 2017/0116576 A1
(43) Pub. Date: Apr. 27, 2017

(54) JOB REFERRAL SYSTEM

(71) Applicant: LinkedIn Corporation, Mountain View, CA (US)

(72) Inventor: Michael Chernyak, Los Gatos, CA (US)

(21) Appl. No.: 14/924,514

(22) Filed: Oct. 27, 2015

(51) Int. Cl. G06Q 10/10; G06Q 50/00; H04L 29/08

(52) U.S. Cl. CPC G06Q 10/1053; H04L 67/306; H04L 67/02; G06Q 50/01

(57) ABSTRACT

A job referral system is provided with an on-line social network system. In response to detecting that a member profile has been identified as representing a member that is a potential candidate for a job represented by a job posting, the job referral system identifies the name of the target organization, at which the target job is being advertised via the job posting, and a connection of that member who is currently employed at the target organization. The job posting is then communicated to that connection, together with a referral invitation message.

### TECHNICAL FIELD

This application relates to the technical fields of software and/or hardware technology and, in one example embodiment, to system and method to select a source of job referral for a member in an on-line social network system.

### BACKGROUND

An on-line social network may be viewed as a platform to connect people in virtual space. An on-line social network may be a web-based platform, such as, e.g., a social networking web site, and may be accessed by a use via a web browser or via a mobile application provided on a mobile phone, a tablet, etc. An on-line social network may be a business-focused social network that is designed specifically for the business community, where registered members establish and document networks of people they know and trust professionally. Each registered member may be represented by a member profile. A member profile may be represented by one or more web pages, or a structured representation of the member's information in XML (Extensible Markup Language), JSON (JavaScript Object Notation) or similar format. A member's profile web page of a social networking web site may emphasize employment history and education of the associated member.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to select a source of job referral for a member in an on-line social network system may be implemented;

FIG. 2 is block diagram of a system to select a source of job referral for a member in an on-line social network system, in accordance with one example embodiment;

FIG. 3 is a flow chart illustrating a method to select a source of job referral for a member in an on-line social network system, in accordance with an example embodiment; and

FIG. 4 is a diagrammatic representation of an example machine in the form of a computer system within which a set of instructions, for causing the machine to perform any one or more of the methodologies discussed herein, may be executed.

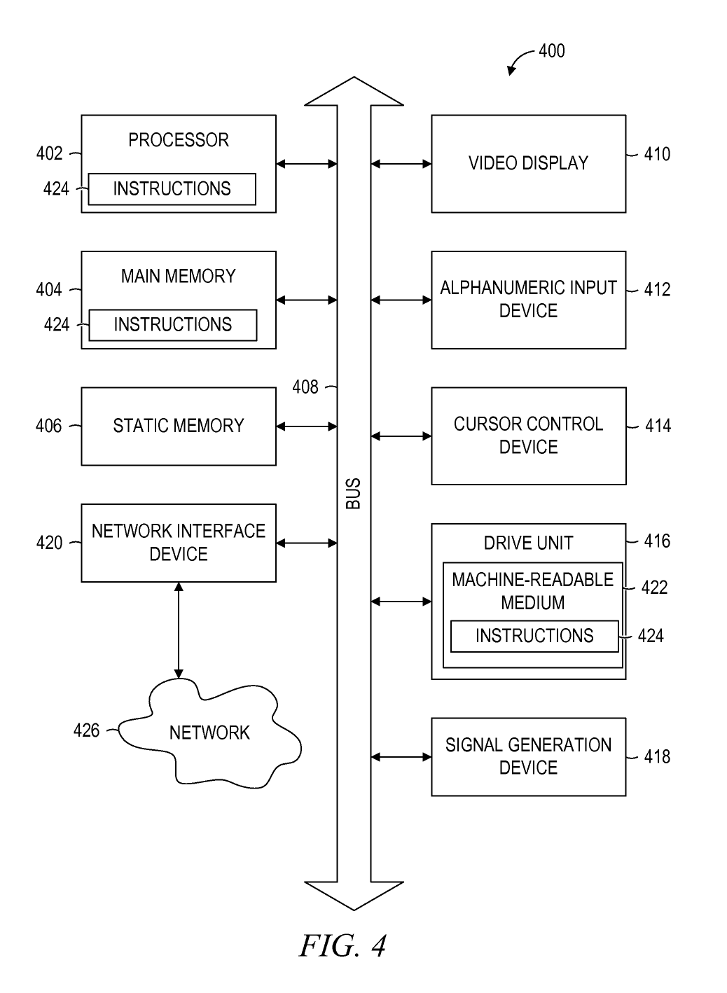

### DETAILED DESCRIPTION

A method and system to select a source of job referral for a member in an on-line social network system is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

For the purposes of this description the phrase “an on-line social networking application” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members. For the purposes of this description, registered members of an on-line social network may be referred to as simply members.

Each member of an on-line social network is represented by a member profile (also referred to as a profile of a member or simply a profile). The profile information of a social network member may include personal information such as, e.g., the name of the member, current and previous geographic location of the member, current and previous employment information of the member, information related to education of the member, information about professional accomplishments of the member, publications, patents, etc. The profile information of a social network member may also include information about the member's professional skills, such as, e.g., “product management,” “patent prosecution,” “image processing,” etc.). The profile of a member may also include information about the member's current and past employment, such as company identifications, professional titles held by the associated member at the respective companies, as well as the member's dates of employment at those companies.

A member profile is also associated with social links that indicate the associated member's connection to other members of the social network. Any two members of a social network may indicate their mutual willingness to be “connected” in the context of the social network, in that they can view each other's profiles, profile recommendations and endorsements for each other and otherwise be in touch via the social network. Members who are connected in the context of a social network may be termed each other's “connections” and their respective profiles are associated with respective connection links indicative of these two profiles being connected.

An on-line social network system also maintains information about various companies, as well as so-called job postings. A job posting, for the purposes of this description is an electronically stored entity that includes information that an employer may post with respect to a job opening. The information in a job posting may include, e.g., the industry, job position, required and/or desirable skills, geographic location of the job, the name of a company, etc. In one embodiment, the on-line social network system includes or is in communication with a so-called recommendation engine, which is configured to match member profiles with job postings. When a member profile has been identified as representing a potential good candidate for a job advertised by a particular job posting, that job posting is presented to the member, e.g., via an email, on the news feed page of the member, as a pop-up message when the member accesses the on-line social network system using a browser application of a mobile app, etc. A recommendation engine may be provided in the form of a binary classifier that can be trained using a set of training data. The set of training data can be constructed using historical data, such as, e.g., data that indicates whether a certain job posting presented to a certain member resulted in that member applying for that job, whether the member viewed the job posting, shared it with other members, etc. A trained binary classifier may be used to generate, for a (member profile, job posting) pair, a value indicative of the likelihood that a member represented by the member profile applies for a job represented by the job posting. A value indicative of the likelihood that a member represented by the member profile applies for a job represented by the job posting may be referred to as a relevance value or a degree of relevance. A member profile, for which a relevance value with respect to a particular job posting is equal to or greater than a predetermined threshold value, may be identified as a candidate member profile with respect to that job posting. Conversely, job posting, for which a relevance value with respect to a particular member profile is equal to or greater than a predetermined threshold value, may be identified as potentially of interest to a member represented by the particular member profile.

A job posting may be presented to a member, who is potentially a good candidate for an associated job, in response to a job search request initiated by the member within the on-line social network system. In the absence of an explicit job search request from a member, who is potentially a good candidate for a job, presenting an associated job posting to the member may be perceived by the member as irrelevant or even intrusive. In order to facilitate more effective delivery of job postings to qualified candidates in the context of an on-line social networking system, a so-called job referral system is provided as part of or in communication with the on-line social networking system. The job referral system detects that a member profile has been identified, by a recommendation engine, as representing a member that is a potentially desirable candidate for a job represented by a job posting. Such profile may be referred to as a candidate member profile. The job referral system then identifies the name of the organization, at which the target job is being advertised via the job posting. The organization, at which the job is being advertised via the job posting, may be referred to as the target organization. The target organization may be a company, a law firm, a university, etc. Next, the job referral system examines connections associated with the candidate member profile to identify a connection that is currently employed at the target organization. Such profile, which may be referred to as a referring member profile, represents an employee of the target organization who is also a connection of the potential job candidate for the target job. After at least one referring member profile has been identified, the job referral system communicates the job posting to the member represented by the referring member profile, together with a message informing the associated employee of the target organization that one of their connections may be a good match for a current job opening at that target company and suggesting that they forward the job posting to that connection. Such message may be of various styles, from official to informal, and may include information about a possibility of a referral bonus, as well as a request to share with the system, an opinion of whether the candidate member is indeed a good match for the job. In general, such message may be termed a referral invitation message.

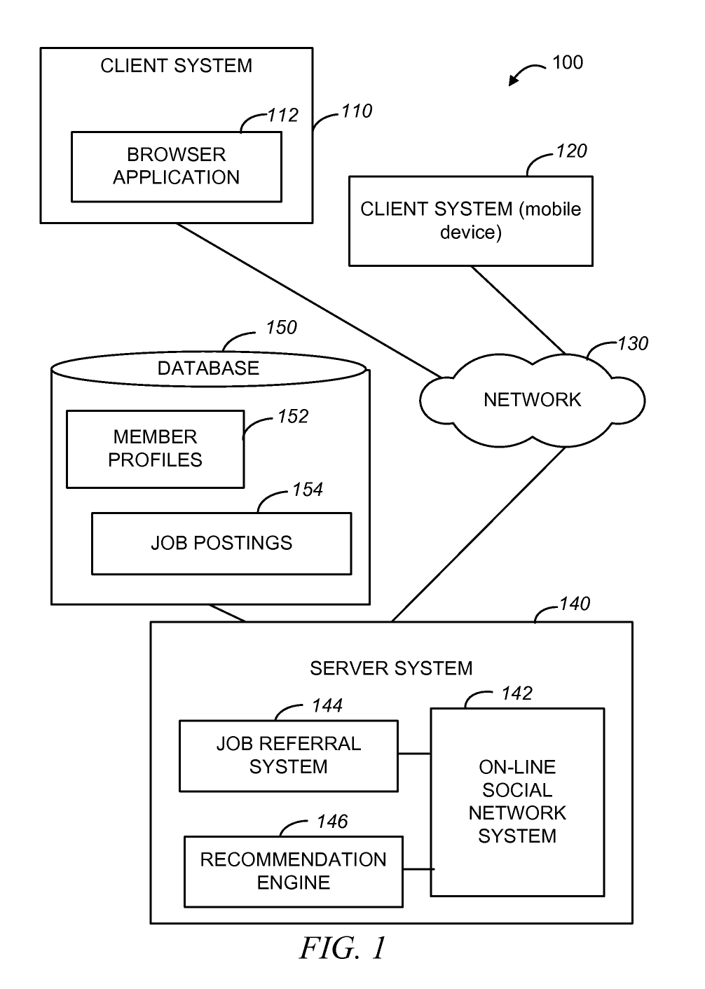

A referral invitation message may be delivered via an email, on the news feed page of the referring member, as a pop-up message when the referring member accesses the on-line social network system using a browser application of a mobile app, etc. The referring member engagement with the referral invitation message can be used to improve the accuracy of a recommendation engine and also to ascertain better the candidate member's suitability for certain types of jobs. An example job referral system may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may be stored in a database 150 as member profiles 152. The database 150 also stores job postings 154. It will be noted that, in some embodiments, the database 150 is considered to be part of the on-line social network system 142.

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a job referral system 144 and a recommendation engine 146. It will be noted that, in some embodiments, the job referral system 144 and the recommendation engine 146 are considered to be part of the on-line social network system 142. The recommendation engine 146 is configured to match member profiles with respective job postings stored in the database 150, as described above.

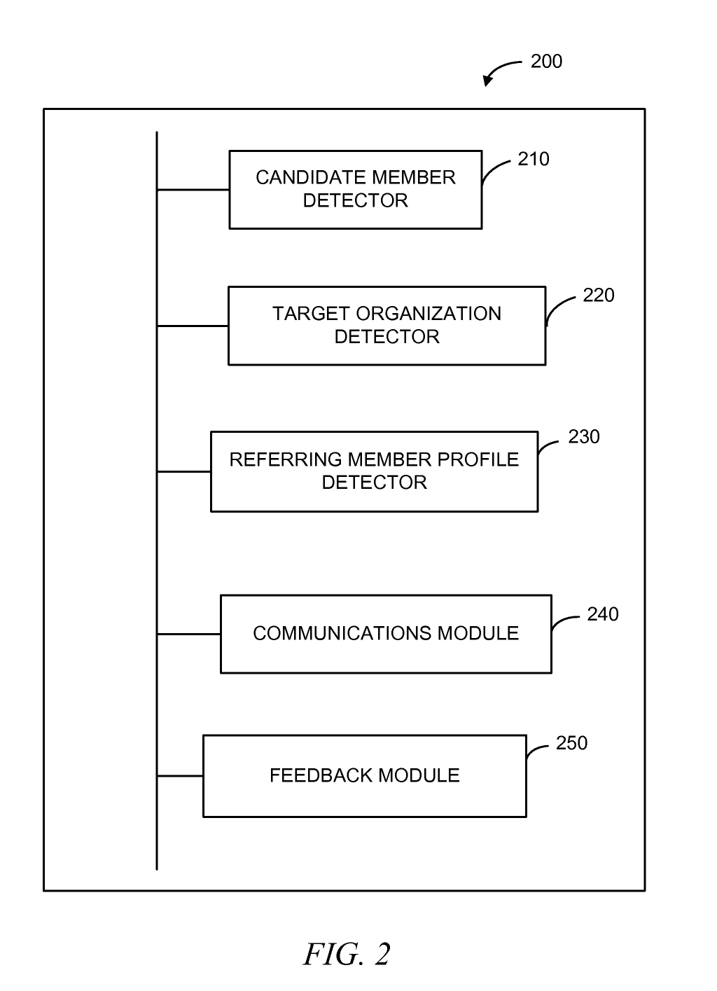

The job referral system 144 may be configured to detect that a member profile has been identified as representing a member that is a potential candidate for a job represented by a job posting, identify the name of the target organization, at which the target job is being advertised via the job posting, and also identify a connection of that member who is currently employed at the target organization. The job referral system 144 may then communicate the job posting to that connection, together with a referral invitation message, as described above. An example job referral system 144 is illustrated in FIG. 2.

FIG. 2 is a block diagram of a system 200 to select a source of job referral for a member in an on-line social network system 142 of FIG. 1. As shown in FIG. 2, the system 200 includes a candidate member detector 210, a target organization detector 220, a referring member profile detector 230, and a communications module 240. The candidate member detector 210 is configured to detect that a candidate member profile from the member profiles 152 stored in the database 150 of the on-line social network system 142 of FIG. 1 has been matched with a job posting. As explained above, the matching can be performed by the recommendation engine 146 of FIG. 1, which, in one embodiment, is a binary classifier configured to generate, for a member profile, a value indicative of a likelihood that a member represented by the member profile applies for a job represented by a particular job posting. The target organization detector 220 is configured to determine, from the job posting, an identification of a target organization, at which a target job is being advertised via the job posting.

The referring member profile detector 230 is configured to identify a referring member profile from member profiles that are connected with the candidate member profile via respective connection links. The referring member profile represents a member who is currently employed at the target organization. In one embodiment, the referring member profile detector 230 examines a current job field representing a current job position in a selected profile that is one of the connected profiles with respect to the candidate member profile, and identifies the selected profile as the referring member profile if the data in the current job field of the selected profile corresponds to data representing the target organization in the job posting. As explained above, a member profile connected to another member profile is associated with a link that indicated such connection.

The communications module 240 is configured to communicate the job posting to the member represented by the referring member profile. The job posting may be communicated together with a referral invitation message that may suggest that the referring member communicates the job posting to the candidate represented by the candidate member profile. A referral invitation message may also include a visual control actionable to collect feedback regarding suitability for the target job of a candidate represented by the candidate member profile. For example, the visual control may be a pair of buttons (e.g., “YES” and “NO”) that could be activated to indicate whether the referring member thinks that the candidate is indeed suitable for the job listed in the job posting.

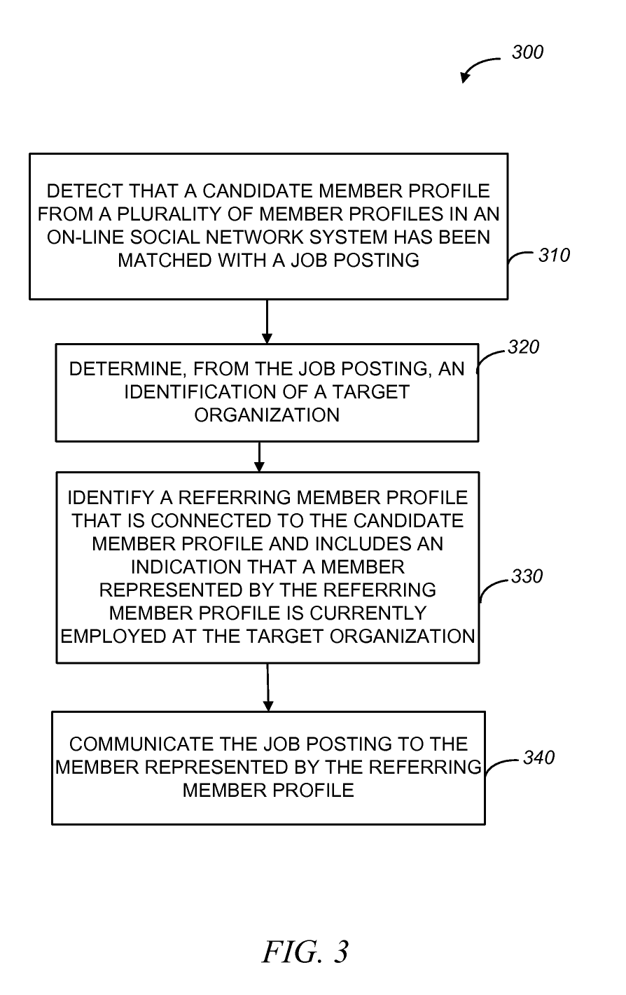

The system 200 may also include a feedback module 250. The feedback module 250 is configured to detect feedback collected in response to activating the visual control and utilize the feedback for a further purpose. For example, the feedback collected from the referring member (information derived from the feedback) may be stored as associated with the candidate member profile. The feedback module 250 may also be configured to derive, from the feedback, information to be used to improve accuracy of the recommendation engine 144 of FIG. 1. When the communications module 240 detects that the job posting was communicated from the referring member profile to a member represented by the candidate member profile, the associated information is provided to the feedback module 250. Some operations performed by the system 200 may be described with reference to FIG. 3.

FIG. 3 is a flow chart of a method 300 to select a source of job referral for a member in an on-line social network system 142 of FIG. 1. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the candidate member detector 210 of FIG. 2 detects that a candidate member profile from the member profiles 152 has been matched with a job posting. At operation 320, the target organization detector 220 of FIG. 2 determines, from the job posting, an identification of a target organization, at which a target job is being advertised via the job posting. At operation 330, the referring member profile detector 230 of FIG. 2 identifies a referring member profile that represents a member who is currently employed at the target organization and is also a connection of a member represented by the candidate member profile. The communications module 240 of FIG. 2 communicates the job posting to the member represented by the referring member profile at operation 340.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

FIG. 5 is a diagrammatic representation of a machine in the example form of a computer system 500 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 505. The computer system 500 may further include a video display unit 510 (e.g., a liquid crystal display (LCD) or a cathode ray tube (CRT)). The computer system 500 also includes an alpha-numeric input device 512 (e.g., a keyboard), a user interface (UI) navigation device 514 (e.g., a cursor control device), a disk drive unit 516, a signal generation device 518 (e.g., a speaker) and a network interface device 520.

The disk drive unit 516 includes a machine-readable medium 522 on which is stored one or more sets of instructions and data structures (e.g., software 524) embodying or utilized by any one or more of the methodologies or functions described herein. The software 524 may also reside, completely or at least partially, within the main memory 504 and/or within the processor 502 during execution thereof by the computer system 500, with the main memory 504 and the processor 502 also constituting machine-readable media.

The software 524 may further be transmitted or received over a network 526 via the network interface device 520 utilizing any one of a number of well-known transfer protocols (e.g., Hyper Text Transfer Protocol (HTTP)).

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### MODULES, COMPONENTS AND LOGIC

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, a method and system to select a source of job referral for a member in an on-line social network system has been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer-implemented method comprising:
detecting that a candidate member profile from a plurality of member profiles in an on-line social network system has been matched with a job posting;
determining, from the job posting, an identification of a target organization, at which a target job is being advertised via the job posting;
identifying, using at least one processor, a referring member profile from member profiles that are connected with the candidate member profile via respective connection links, the referring member profile being connected to the candidate member profile via a connection link and including an indication that a member represented by the referring member profile is currently employed at the target organization; and
communicating the job posting to the member represented by the referring member profile, the communicating comprising causing presentation of the job posting on a display device.

2. The method of claim 1, comprising communicating a referral invitation message, together with the job posting, to the member represented by the referring member profile.

3. The method of claim 2, wherein the referral invitation message includes a visual control actionable to collect feedback regarding suitability for the target job of a candidate represented by the candidate member profile.

4. The method of claim 3, comprising:
detecting feedback collected in response to activating the visual control; and
utilizing the feedback for a further purpose.

5. The method of claim 4, wherein the utilizing of the feedback comprises storing information derived from the feedback as associated with the candidate member profile.

6. The method of claim 4, wherein the utilizing of the feedback comprises deriving, from the feedback, information to be used to improve accuracy of a recommendation engine, the recommendation engine to match member profiles from the plurality of member profiles with respective job postings stored in the on-line social network system.

7. The method of claim 6, wherein the recommendation engine is a binary classifier configured to generate, for a member profile from the plurality of member profiles, a value indicative of a likelihood that a member represented by the member profile applies for a job represented by the job posting.

8. The method of claim 1, comprising detecting that the job posting was communicated from the referring member profile to a member represented by the candidate member profile.

9. The method of claim 1, comprising:
examining a current job field representing a current job position in a selected profile, the selected profile associated with a link indicating that the selected profile is connected with the candidate member profile;
determining that data in the current job field corresponds to data representing the target organization in the job posting; and
based on the determining, identifying the selected profile as the referring member profile.

10. The method of claim 1, wherein the target organization is a company, a law firm, or a university.

11. A computer-implemented system comprising:
a candidate member detector, implemented using at least one processor, to detect that a candidate member profile from a plurality of member profiles in an on-line social network system has been matched with a job posting;
a target organization detector, implemented using at least one processor, to determine, from the job posting, an identification of a target organization, at which a target job is being advertised via the job posting;
a referring member profile detector, implemented using at least one processor, to identify a referring member profile from member profiles that are connected with the candidate member profile via respective connection links, the referring member profile being connected to the candidate member profile via a connection link and including an indication that a member represented by the referring member profile is currently employed at the target organization; and
a communications module, implemented using at least one processor, to communicate the job posting to the member represented by the referring member profile and to cause presentation of the job posting on a display device.

12. The system of claim 11, wherein the communications module is to communicate a referral invitation message, together with the job posting, to the member represented by the referring member profile.

13. The system of claim 12, wherein the referral invitation message includes a visual control actionable to collect feedback regarding suitability for the target job of a candidate represented by the candidate member profile.

14. The system of claim 13, comprising a feedback module, implemented using at least one processor, to:
detect feedback collected in response to activating the visual control; and
utilize the feedback for a further purpose.

15. The system of claim 14, wherein the feedback module is to store information derived from the feedback as associated with the candidate member profile.

16. The system of claim 14, wherein the feedback module is to derive, from the feedback, information to be used to improve accuracy of a recommendation engine, the recommendation engine to match member profiles from the plurality of member profiles with respective job postings stored in the on-line social network system.

17. The system of claim 16, wherein the recommendation engine is a binary classifier configured to generate, for a member profile from the plurality of member profiles, a value indicative of a likelihood that a member represented by the member profile applies for a job represented by the job posting.

18. The system of claim 11, wherein the communications module is to detect that the job posting was communicated from the referring member profile to a member represented by the candidate member profile and provide the associated information to the feedback module.

19. The system of claim 11, wherein the referring member profile detector is to:
examine a current job field representing a current job position in a selected profile, the selected profile associated with a link indicating that the selected profile is connected with the candidate member profile;
determine that data in the current job field corresponds to data representing the target organization in the job posting; and
based on the determining, identify the selected profile as the referring member profile.

20. A machine-readable non-transitory storage medium having instruction data executable by a machine to cause the machine to perform operations comprising:
detecting that a candidate member profile from a plurality of member profiles in an on-line social network system has been matched with a job posting;
determining, from the job posting, an identification of a target organization, at which a target job is being advertised via the job posting;
identifying a referring member profile from member profiles that are connected with the candidate member profile via respective connection links, the referring member profile being connected to the candidate member profile via a connection link and including an indication that a member represented by the referring member profile is currently employed at the target organization; and
communicating the job posting to the member represented by the referring member profile, the communicating comprising causing presentation of the job posting on a display device.
